(19) United States
(12) Patent Application Publication
(10) Pub. No.: US 2012/0263971 A1
(43) Pub. Date: Oct. 18, 2012

(54) BASE METAL ALLOYS WITH IMPROVED CONDUCTIVE PROPERTIES, METHODS OF MANUFACTURE, AND USES THEREOF

(75) Inventors: Mark AINDOW, Tolland, CT (US); S. Pamir ALPAY, South Windsor, CT (US); Joseph V. MANTESE, Ellington, CT (US)

(73) Assignee: UNIVERSITY OF CONNECTICUT, Farmington, CT (US)

(21) Appl. No.: 13/269,076

(22) Filed: Oct. 7, 2011

Related U.S. Application Data
(60) Provisional application No. 61/512,613, filed on Jul. 28, 2011.
(60) Provisional application No. 61/404,764, filed on Oct. 8, 2010.

(51) Int. Cl. H01B 1/02; B32B 15/01; C22C 38/12; C23C 8/00; C22C 38/04

(52) U.S. Cl. 428/681; 148/284; 420/72; 420/120; 420/123; 420/127; 420/8; 428/457

(57) ABSTRACT

A composition comprises a binary alloy of iron and one of manganese, molybdenum, or vanadium, wherein the manganese, molybdenum, or vanadium is present in the binary alloy in an amount effective to form a conductive oxide on the binary alloy, the oxidation state of the manganese, the molybdenum, and the vanadium is greater than the oxidation state of iron in the conductive oxide, and the conductive oxide has a contact resistance of less than 5×10⁴ milli-ohms measured in accordance with ASTM B667-97 (2009).

### CROSS-REFERENCE TO RELATED APPLICATIONS

This application claims the benefit of U.S. Provisional Patent Application Ser. No. 61/512,613, filed Jul. 28, 2011, and U.S. Provisional Patent Application Ser. No. 61/404,764, filed Oct. 8, 2010, which are both incorporated by reference herein in their entirety.

### STATEMENT REGARDING FEDERALLY SPONSORED RESEARCH

This invention was made with government support under Grant No. W-911-NF0710388 awarded by the U.S. Army Research Office. The government has certain rights in the invention.

### BACKGROUND

Electrical contacts are used in many devices for current delivery between components. In many applications, a transition metal is selected as a base metal of the electrical contact, and a thin layer of a precious metal, e.g., gold, silver, or platinum, is plated on the base metal. The precious metal layer is used to maintain a relatively low contact resistance of the electrical contact and its mating contact. High contact resistance can lead to open circuit characteristics that impede current flow. Further, the contact resistance of the base metal can increase over time leading to device failure. Beyond electrical failure, increasing contact resistance can cause increased local heating and thermal problems in devices.

One source of increased contact resistance is the formation of metallic oxides at the contact surfaces. For example, mechanical vibration or different thermal expansion rates of the electrical contact and its mate can cause relative movement of the electrical contact. Such movement can be abrasive, exposing the base metal of the contact that is then subject to oxidation. Because the oxidized debris can be much harder than the surfaces from which it came, it can act as an abrasive agent that increases the rate of both fretting and mechanical wear. As more fresh base metal is exposed and oxidized, the contact resistance increases, and electrical failure can occur.

Precious metals are generally used to decrease the oxidation rate of the base metal in an electrical contact. However, precious metals are costly and can be difficult to procure. There accordingly remains a need in the art for materials and methods that decrease the oxidation of the base metal in an electrical contact.

### SUMMARY

Disclosed herein is a composition comprising a binary alloy of iron and one of manganese, molybdenum, or vanadium, wherein the manganese, molybdenum, or vanadium is present in the binary alloy in an amount effective to form a conductive oxide from the binary alloy, the oxidation state of the manganese, molybdenum, and vanadium is greater than the oxidation state of the iron in the conductive oxide, and the conductive oxide has a contact resistance of less than 5×10⁴ milli-ohms measured in accordance with ASTM B667-97 (2009).

In a specific embodiment, the composition further comprises the conductive oxide of the binary alloy.

Also disclosed herein is a process of making a binary alloy comprising alloying iron and one of manganese, molybdenum, or vanadium to form the binary alloy.

In addition, disclosed herein is a process of making a composition comprising a binary alloy and a conductive oxide of the binary alloy, the process comprising alloying iron and one of manganese, molybdenum, or vanadium to form the binary alloy; and maintaining the alloy under a condition effective to oxidize at least a portion of the binary alloy to form the conductive oxide.

An electrical device comprises a first component and a second component in a spaced apart relation; and the binary alloy or the composition comprising the binary alloy and the conductive oxide of the binary alloy disposed between and in physical contact with the first component and the second component, wherein the binary alloy or the composition completes an electrical path between the first component and the second component.

The above described and other features are exemplified by the following figures and detailed description.

### BRIEF DESCRIPTION OF THE DRAWINGS

Referring now to the figures, which are embodiments, and wherein like elements are numbered alike:

FIG. 1 is a cross-section of an embodiment of a binary alloy of Fe—X with a conductive oxide (Fe,X)₃O₄ scale;

FIG. 2 is a model of electron/polaron hopping in an embodiment of a conductive oxide of a binary alloy;

FIG. 3 is a secondary electron scanning electron microscope image of an embodiment of an Fe—V alloy;

FIG. 4 is a graph of relative intensity (arbitrary units, a.u.) versus scattering angle (degrees, 2θ) data from an X-ray diffraction pattern of an embodiment of a conductive oxide of an Fe—V alloy;

FIG. 5 is an electron diffraction pattern of the conductive oxide of the Fe—V alloy corresponding to the data shown in FIG. 4;

FIG. 6 is a graph of contact resistance (milli-ohms, mΩ) versus oxidation time (hours, hr) for a Cu sample, an Fe sample, and an embodiment of a conductive oxide of an Fe-8V alloy;

FIG. 7 is a phase diagram of temperature (degrees Celsius, ° C.) versus weight percent V (wt. % V) and atomic percent V (at. % V) for an Fe—V system;

FIG. 8 is a graph of contact resistance (milli-ohms, mΩ) versus oxidation time (hours, hr) for a Cu sample, an Fe sample, and an embodiment of a conductive oxide of an Fe-4V alloy, Fe-8V alloy, Fe-12V alloy, Fe-16V alloy, and Fe-20V alloy;

FIG. 9 is a phase diagram of temperature (degrees Celsius, ° C.) versus weight percent Mn (wt. % Mn) and atomic percent Mn (at. % Mn) for an Fe—Mn system;

FIG. 10 is a graph of contact resistance (milli-ohms, mΩ) versus oxidation time (hours, hr) for a Cu sample, an Fe sample, and an embodiment of a conductive oxide of an Fe-1Mn alloy, Fe-2Mn alloy, Fe-3Mn alloy, Fe-4Mn alloy, and Fe-5Mn alloy;

FIG. 11 are phase diagrams of temperature (degrees Celsius, ° C.) versus weight percent Mo (wt. % Mo) and atomic percent Mo (at. % Mo) for an Fe—Mo system; and

FIG. 12 is a graph of contact resistance (milli-ohms, mΩ) versus oxidation time (hours, hr) for a Cu sample, an Fe sample, and an embodiment of a conductive oxide of an Fe-1Mo alloy, Fe-2Mo alloy, Fe-3Mo alloy, Fe-4Mo alloy, and Fe-5Mo alloy.

### DETAILED DESCRIPTION

The inventors hereof have discovered that a limited number of binary alloys, in particular binary alloys containing iron and a specific amount of one of manganese, molybdenum, or vanadium can form conductive oxides. The binary alloys are highly useful as electrical contacts, where oxidation of the electrical contact using prior art materials ordinarily forms a non-conductive oxide. The production of non-conductive oxides can severely limit the performance and/or life of an electrical device. In some instances, formation of a non-conductive oxide can compromise the safety of the device. Use of the inventive binary alloys can therefore improve one or more the performance of an electrical device over time, increase the lifetime of the device, or improve the safety of the device. Use of the inventive binary alloys further provides a lower cost alternative to prior art electrical contact materials because the binary alloys are not required to be coated with a precious metal, e.g., gold, silver, or platinum. The binary alloys can therefore decrease the use of precious metal plating of electrical contacts while conserving the operational characteristics of such current-carrying contacts.

In an embodiment, binary alloys are described that contain two elements: iron and one of manganese, molybdenum, or vanadium in specified amounts. For convenience, these binary alloys can be referred to herein as Fe—V, Fe—Mn, and Fe—Mo, or generally as Fe—X with X being manganese, molybdenum, or vanadium. As is known to those of skill in the art, the materials used in the manufacture of alloys often contain low levels of various impurities, particularly metal-, carbon-, or nitrogen-containing impurities. Such impurities can be present in the binary alloys described herein, provided that such impurities are not present in an amount that significantly adversely affects the desired properties of the alloys, in particular the formation of a conductive oxide. Impurities may be present in the binary alloy in minor amounts due to, for example, the inherent properties of iron, manganese, molybdenum, or vanadium or may be present due, for example, to leaching from contact with manufacturing equipment or uptake during processing of the binary alloy. For example, the binary alloys can contain less than 1 weight percent (wt. %), less than 0.5 wt. %, or less than 0.1 wt. % of materials other than the iron and one of manganese, molybdenum, or vanadium, based on the total weight of the binary alloy.

In order to obtain a binary alloy that forms a conductive oxide, the amount of iron and the manganese, molybdenum, or vanadium are carefully adjusted.

The Fe—Mn binary alloy contains manganese in an amount from 1 atomic percent (at. %) to 10 at. %, specifically 1 at. % to 5 at. %, and more specifically 3 at. % to 5 at. %, based on the total weight of the alloy, with the balance being iron. In an embodiment, the Fe—Mn binary alloy contains 4 at. % manganese, based on the total weight of the alloy, with the balance being iron. Fe—Mo binary alloy contains molybdenum in an amount from about 1 at. % to about 10 at. %, specifically about 2 at. % to about 10 at. %, and more specifically about 2.5 at. % to about 5 at. %, based on the total weight of the alloy, with the balance being iron. In an embodiment, the Fe—Mo binary alloy contains about 5 at. % molybdenum, based on the total weight of the alloy, with the balance being iron.

The Fe—V binary alloy contains vanadium in an amount from about 2 at. % to about 22 at. %, specifically about at. % to about 20 at. %, and more specifically about 8 at. % to about 20 at. %, based on the total weight of the alloy, with the balance being iron. In an embodiment, the Fe—V binary alloy contains about 20 at. % vanadium, based on the total weight of the alloy, with the balance being iron.

In the binary alloy, the manganese, molybdenum, or vanadium can be miscible in the iron so that a solid solution is formed in the binary alloy. Alternatively, the manganese, molybdenum, or vanadium can be partially insoluble in the iron. Under the latter condition, the binary alloy can form two or more phases.

Moreover, the manganese, molybdenum, or vanadium is miscible in a melt of the iron and is soluble in the solid binary alloy and the oxide of the binary alloy, i.e., the binary alloy and its oxide are solid solutions having a single phase.

The binary alloys can be produced by methods known in the art for alloys. In an embodiment, selected amounts of the iron and manganese, molybdenum, or vanadium are combined at a temperature effective to produce a melt of the metals. The metals can be combined and then melted, or a melt of the iron is combined with the manganese, molybdenum, or vanadium. Alternatively, the binary alloys can be prepared by depositing, implanting, or doping the iron with the manganese, molybdenum, or vanadium.

The binary alloys have excellent properties for use as electrical contacts.

The binary alloys can have a bulk resistivity of less than or equal to 500 nano-ohm-meters (nΩ-m), specifically 25 nΩ-m to 500 nΩ-m, 50 nΩ-m to 500 nΩ-m, 25 nΩ-m to 350 nΩ-m, or 50 nΩ-m to 350 nΩ-m.

Binary alloys having the foregoing compositions can form a conductive oxide. Thus in another embodiment, a composition comprises a binary alloy and a conductive oxide of the binary alloy, specifically a conductive oxide formed from the binary alloy. As used herein, “an oxide” or “the oxide” includes multiple oxides, if multiple oxides are formed.

In the conductive oxide, the manganese, molybdenum, or vanadium has a higher valence than the iron cations in the conductive oxide. The oxide exists in a separate phase (or phases) from the binary alloy. The oxide is formed on and in direct contact with a surface of the alloy and may partially or completely cover the surface. The binary alloy can be oxidized on a surface of the alloy, or oxidation can penetrate into the bulk material of the binary alloy. The conductive oxide can have one or more separate phases. Alternatively, the conductive oxide can be present as a single phase on the surface of the binary alloy or can penetrate into the bulk of the alloy. In an embodiment, the composition comprising the binary alloy and the conductive oxide of the binary alloy is in the form of a solid solution binary alloy with an oxide phase as a film on and in contact with the surface of the binary alloy.

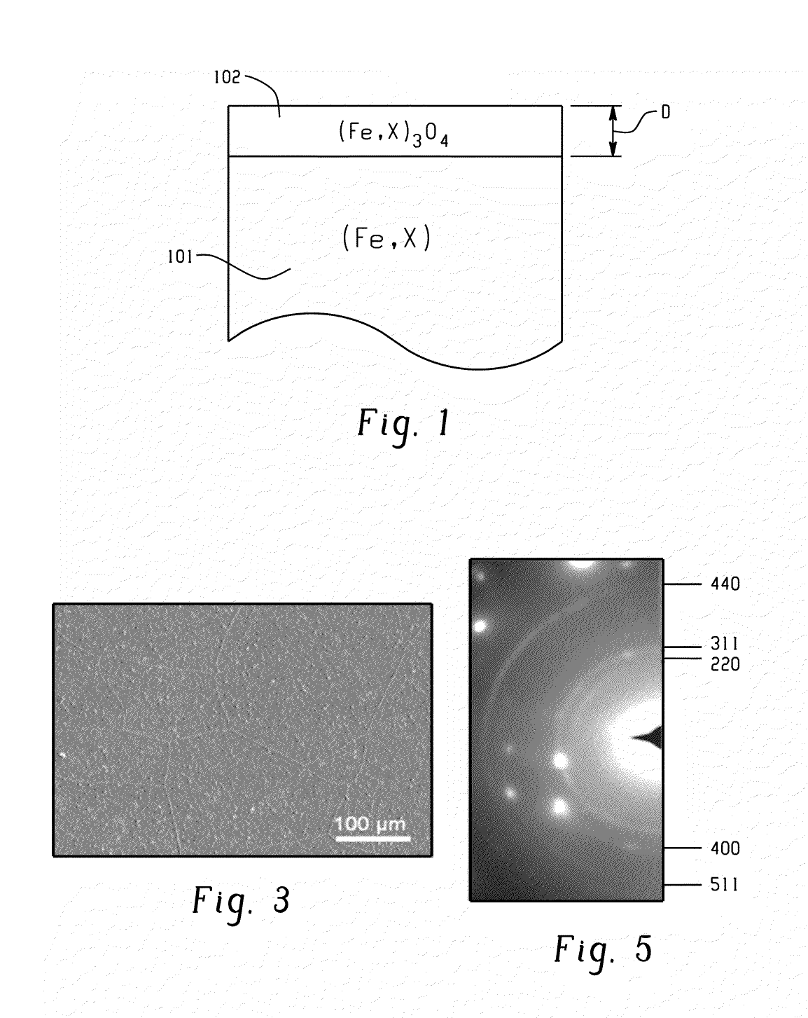

FIG. 1 is a cross-section of an embodiment of a binary alloy with a passivating conductive oxide scale on the surface of the binary alloy. Iron and manganese, molybdenum, or vanadium form a single-phase binary alloy 101 denoted as Fe—X. Oxidation of the binary alloy 101 forms a corresponding single-phase oxide 102 denoted as (Fe,X)₃O₄. The atoms in the oxide 102 are primarily present as ions of Fe²⁺, Fe³⁺, O²⁻, and cations of X. The cations of X can have various oxidation states. For example, if X is vanadium the cations of X can be V⁴⁺ or V⁵⁺. For convenience, the cations of X are referred to as X⁺ even when more than valence can occur. As shown, the oxide 102 is conductive. The thickness D of the conductive oxide 102 is not particularly limited, and can be, for example, 0.5 nm to 100 nm, specifically 1 nm to 50 nm, and more specifically 1 nm to 10 nm.

The foregoing is merely illustrative of the form of the compositions comprising the binary alloys and the conductive oxides of the binary alloys. However, other configurations of the binary alloys and conductive oxides can exist independently or together with the configuration of the embodiment shown in FIG. 1.

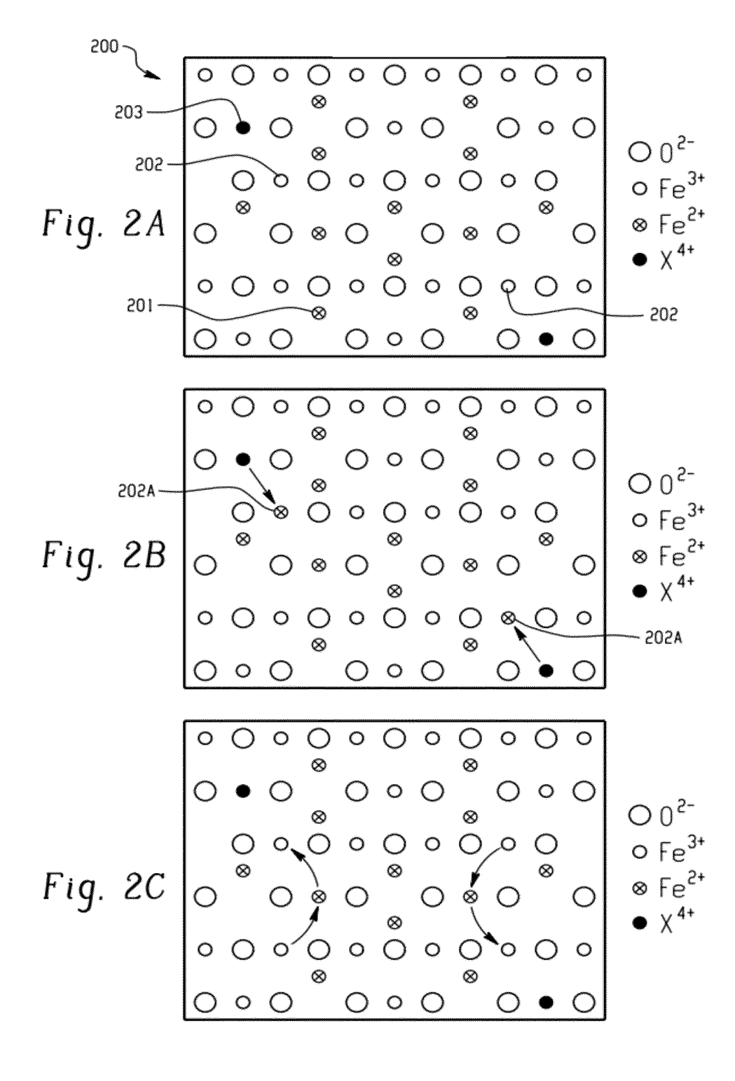

Without being bound to any particular theory, the enhanced conductivity of the compositions comprising the binary alloys and the conductive oxides of the binary alloy can be ascribed to electron/polaron hopping. FIGS. 2A, 2B, and 2C show a model of electron/polaron hopping in an embodiment of a conductive oxide film of a binary alloy. The underlying binary alloy contains iron and manganese, molybdenum, or vanadium. In the conductive oxide film 200, the crystal structure is an inverse spinel magnetite (Fe₃O₄) in which iron exhibits ionic bonding as an ensemble of divalent ferrous ions (Fe²⁺) 201 and trivalent ferric ions (Fe³⁺) 202. The cations of the manganese, molybdenum, or vanadium are present as, for example, tetravalent (X⁴⁺) ions 203 in the oxide film 200. The tetravalent ions 203 substitute for trivalent iron ions 202. As indicated by the straight arrows in FIG. 2B, the tetravalent ions 203 induce a compensating change in the oxidation state of a neighboring iron ion 202A from a trivalent valence (Fe³⁺) to a lower divalent valence (Fe²⁺). The divalent ion on a trivalent ion site is a polaron, which can enhance the conduction of the conductive oxide film 200. As shown in FIG. 2C, the enhancement in conduction occurs by electron/polaron hopping in which the polaron migrates on the trivalent ion sublattice through electron exchange (shown by the curved arrows) with adjacent iron ions in the divalent ion sublattice. Thus, the oxide film 200 is appreciably conductive even though the oxide for pure iron is not as conductive.

Further, for electron/polaron hopping, the bonding in the conductive oxide of the binary alloy is predominantly ionic. It is believed that the conductive oxide film of the binary alloy favors induction of mixed valence states of the iron by the manganese, molybdenum, or vanadium over the formation of oxygen vacancies because the free energy for oxygen vacancy formation is sufficiently large with respect to the energy required for establishing mixed valence states for cations of the iron. Additionally, the free energies of formation for the oxides of the iron and the manganese, molybdenum, or vanadium of the binary alloy are similar so that selective oxidation of either of the iron or manganese, molybdenum, or vanadium is suppressed.

The foregoing is merely illustrative of one principle of forming conductive oxides from binary alloys of the embodiments. However, other mechanisms can exist and, independently or together with the above-described mechanisms shown in FIG. 2, can modulate the conduction of the conductive oxides.

The conductive oxides of the binary alloys can be formed by a variety of processes, including exposure of the binary alloy to ambient conditions, e.g., during use in the atmosphere at ambient levels of humidity. The oxides can be formed under more oxidative conditions and as part of a more aggressive processing procedure. For example, the oxides can be formed by subjecting the binary alloy to a thermally oxidizing or reducing atmosphere; treatment with microwaves, electron beams, or X-rays; chemical treatment in an oxidizing or reducing environment; and the like.

As stated above, the oxides of the binary alloys are conductive. For example, the contact resistance of the composition comprising the binary alloy and the conductive oxide can be less than or equal to 5×10⁴ milli-ohms (mΩ).

The binary alloys can be used in a variety of applications that use a conductive metal, for example, as electrical contacts for electronic devices. An electrical contact formed using the binary alloys can be used in a device before or after oxidation of the binary alloy. Electrical devices generally include a first component and a second component in a spaced apart relation. The binary alloy (or the composition comprising the binary alloy and a conductive oxide of the binary alloy) is disposed between and in physical contact with the first component and the second component to form an electrical path between the first component and the second component. The binary alloy or composition thereof with a conductive oxide of the binary alloy can be in a wide variety of forms as needed to contact the first and the second component. The form may be, for example, a wire, cable, button, coating, and the like.

In an embodiment, the binary alloy or composition thereof with a conductive oxide of the binary alloy is at least a portion of a conductive contact in a connector, switch, or insert. Examples of the connector are a blade connector, push-on connector, crimp connector, multi-pin connector (e.g., a D-sub connector), bolt connector, set screw connector, lug, wedge connector, bolted connector, compression connector, coaxial connector, wall connector, surface mount technology (SMT) board connector, IPC connector, DIN connector, phone connector, plastic leaded chip carrier (PLCC) socket or surface mount connector, integrated circuit (IC) connector, ball grid array (BGA) connector, staggered pin grid array (SPA) connector, and bus bar connector. Switches include, for example, a circuit breaker, mercury switch, wafer switch, dual-inline package (DIP) switch, reed switch, wall switch, toggle switch, in-line switch, rocker switch, microswitch, and rotary switch. An insert can be, for example, a transition washer, disc, and tab.

In an embodiment, a connector includes a metal substrate having a coating comprising the binary alloy or composition thereof with a conductive oxide of the binary alloy disposed on a surface of the metal substrate such that they form an electrically conductive path. A metallic member, e.g., a mate such as a pin couples to the connector to be in electrical contact with the binary alloy or composition thereof. An electric voltage or current can be established by the coupling, and the binary alloy or composition thereof is the conduction path between the metal substrate and the metallic mate.

In another embodiment, a switch includes a metal substrate having the binary alloy or composition thereof with a conductive oxide of the binary alloy disposed on a surface of the metal substrate, to establish an electrically conductive contact. A metallic member, e.g., a pole, couples with the binary alloy or composition thereof of the contact. As a result of this coupling, an electrically conductive path is established between the metallic pole and the contact, with the binary alloy or composition thereof being the conduction path between the metal substrate and the metallic pole.

The binary alloys and compositions comprising the binary alloys and the conductive oxides of the binary alloy have a number of advantages. The oxidized portions of the binary alloys have sufficient conductivity to prevent the development of an unacceptably high contact resistance. Their use can decrease the use of precious metal plating of electrical contacts while conserving the operational characteristics of such current-carrying contacts. In addition, the alloys are readily manufactured from widely available materials.

The binary alloys and compositions comprising the binary alloys and the conductive oxides of the binary alloys are further illustrated by the following examples, which are non-limiting.

### EXAMPLES

In the following examples, arc-melted ingots of the binary alloys were used, and, where necessary, the ingots were heat-treated to produce homogeneous microstructures on the length scales relevant to contact applications, e.g., 10⁻⁴ meters (m) to 10⁻² m. The microstructures of the binary alloys and their conductive oxides were characterized by X-ray diffraction (XRD), scanning electron microscopy (SEM), and transmission electron microscopy (TEM). Electrical data were obtained using 2-probe 4-point methods for bulk conductivities and a single-point hemispherical gold probe for contact resistance per ASTM B667-97 (2009), “Standard Practice for Construction and Use of a Probe for Measuring Electrical Contact Resistance.” Contact resistances were measured for freshly prepared alloy surfaces and for surfaces exposed to air at 100° C. for various times as noted below.

An Fe—V binary alloy containing 8 at. % vanadium and the remainder iron was oxidized by exposure to air at 100° C. for various times to form a conductive oxide on the surface of the alloy.

FIG. 3 is a secondary electron scanning electron microscope image of the Fe-8 at. % V alloy. The Fe-8 at. % V alloy has a single phase with a grain size of greater than 200 micrometers with a resistivity of 301.7 nΩ-m as compared to 102.5 nΩ-m for high-purity iron.

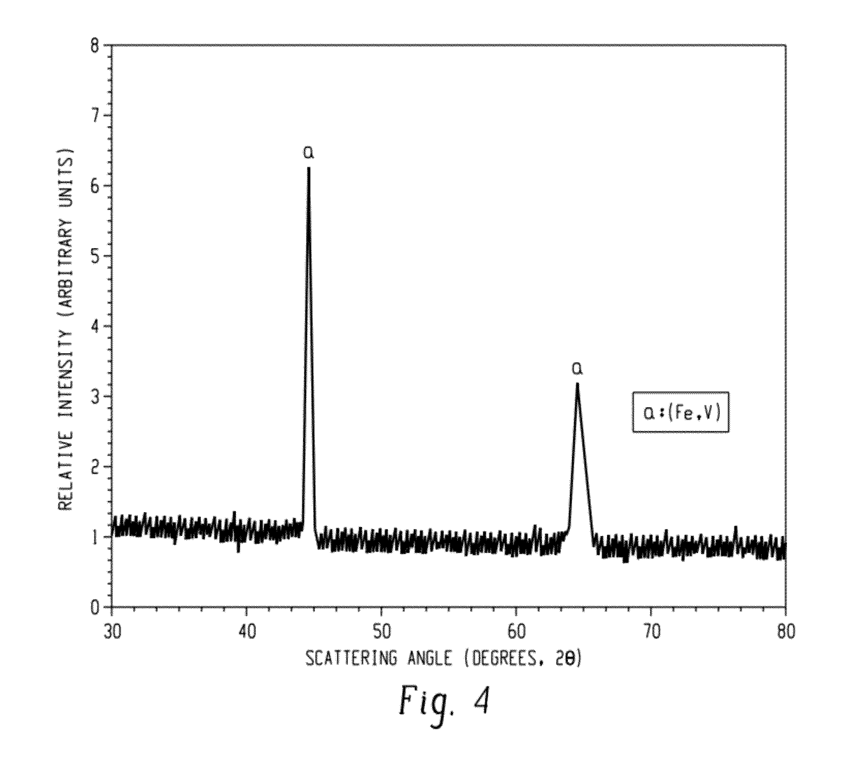

FIG. 4 is a graph of relative intensity (arbitrary units, a.u.) versus scattering angle (degrees, 2θ) data from an XRD pattern of an oxidized Fe-8 at. % V alloy, and FIG. 5 is an electron diffraction (ED) pattern of the oxidized Fe-8 at. % V alloy. The XRD data in FIG. 4 contain only Fe and V peaks (labeled as “a” at approximately 45° and 65°) from the body-centered cubic Fe-8 at. % V alloy phase, and the ED data in FIG. 5 establish that the oxides from the oxidized Fe-8 at. % V alloy correspond to Fe₃O₄ rather than Fe₂O₃, with no evidence for phase separation in the oxide. Therefore, the oxide is a single phase with vanadium substitutionally incorporated into the Fe₃O₄ lattice. The resolved diffraction rings in FIG. 5 correspond to the {440}, {511}, {400}, {311}, and {220} planes of the amorphous Fe₃O₄ crystal structure.

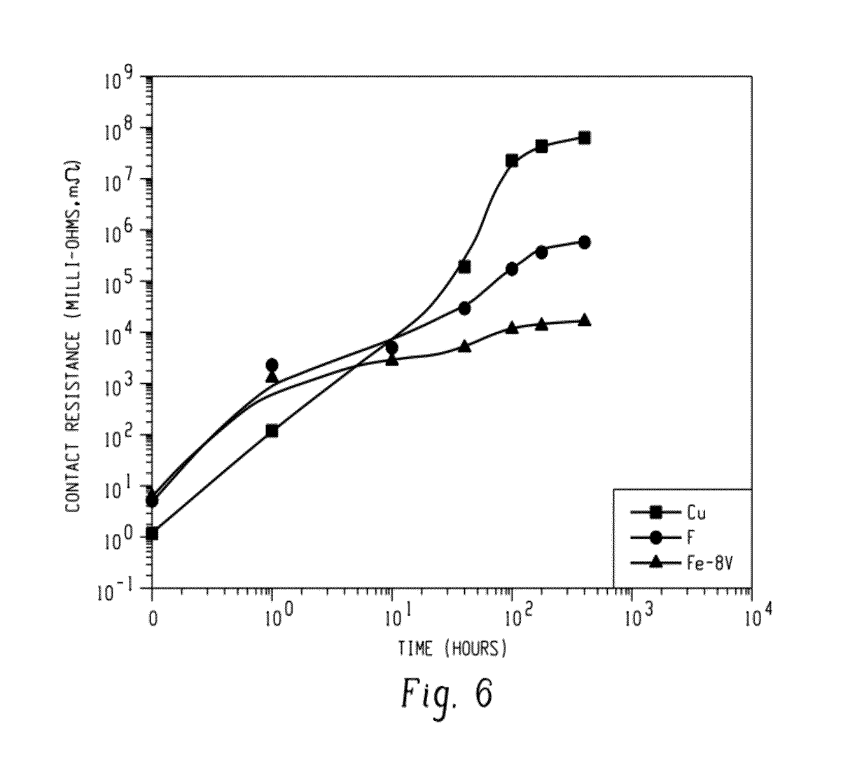

FIG. 6 is a graph of contact resistance (milli-ohms, mΩ) versus oxidation time (hours, hr) for a copper sample, an iron sample, and the Fe-8 at. % V alloy. The oxidized Fe-8 at. % V alloy has a contact resistance that is 1.5 orders of magnitude less than that for pure Fe and four orders of magnitude less than that for pure Cu after air exposure at 100° C. for 100 hours.

The temporal variation in surface resistivity due to enhanced oxide film conductivity of the oxidized Fe-8 at. % V alloy is due to substitutional V⁴⁺ or V⁵⁺ inducing a change in the relative amount of Fe²⁺/Fe⁺ in the oxide film. The mechanism for enhanced oxide film conduction is likely electron/polaron hopping as illustrated in FIG. 2.

Although data shown in FIGS. 3, 4, 5, and 6 are for 8 at. % vanadium in iron, additional embodiments can be produced having other atomic percentage values of V in Fe that produce lower contact resistance after oxidation as compared with oxidized Cu or oxidized Fe.

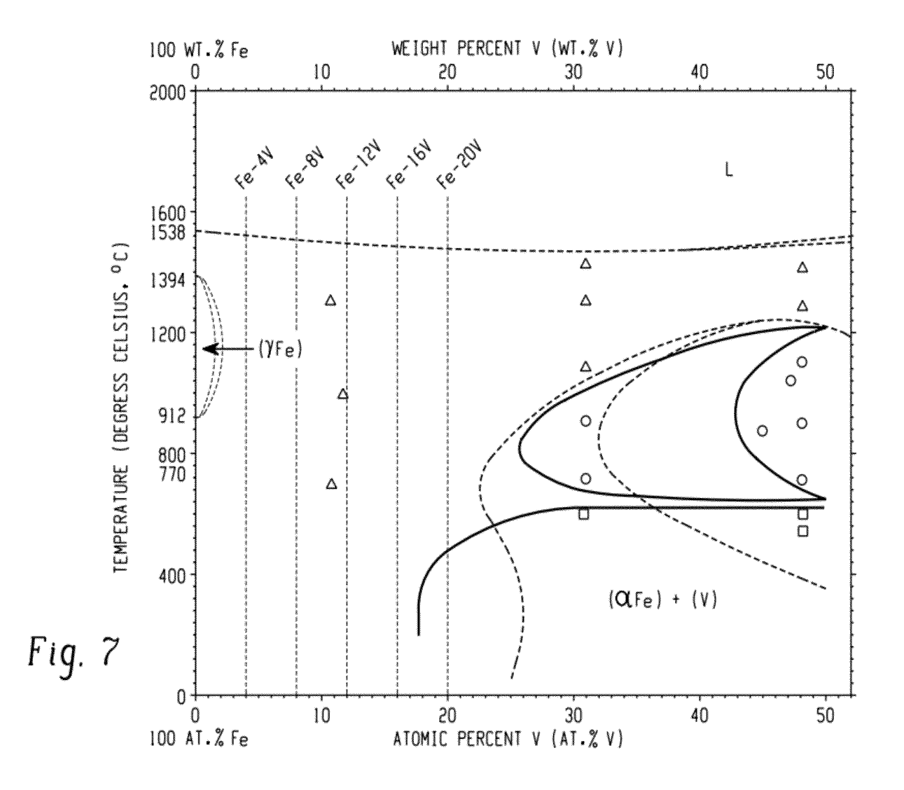

Phase diagrams for compositions of iron with vanadium, manganese, and molybdenum are respectively shown in FIGS. 7, 9, and 11. In addition to the Fe—V system, manganese and molybdenum exhibit solubility in iron. Further, as with vanadium, manganese and molybdenum may have different oxidation states such that each can form a conductive oxide with iron.

FIG. 7 is a phase diagram of temperature (degrees Celsius, ° C.) versus weight percent V (wt. % V) and atomic percent V (at. % V) for an Fe—V system. Vertical dashed lines indicate alloys of iron with 4 at. % V, 8 at. % V, 12 at. % V, 16 at. % V, and 20 at. % V, which have solid states for each composition below about 1538° C. and a liquid state above this temperature. Based on the phase diagram shown in FIG. 7, from a melt of iron and vanadium, an alloy of a single phase α(Fe,V) can be formed below about 1480° C. for about 2 at. % V to about 22 at. % V in a balance of iron.

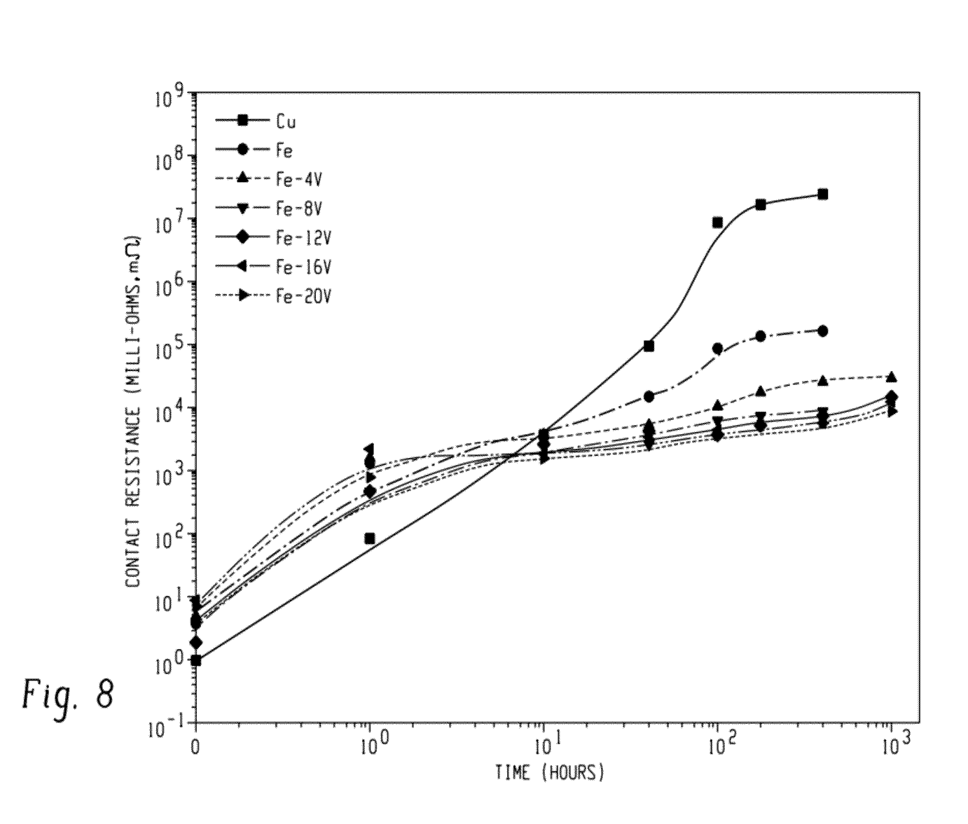

FIG. 8 is a graph of contact resistance (milli-ohms, mΩ) versus oxidation time (hours, hr) for a conductive oxide of an Fe-4 at. % V alloy, Fe-8 at. % V alloy, Fe-12 at. % V alloy, Fe-16 at. % V alloy, and Fe-20 at. % V alloy and comparative results for copper and iron samples. As described above for Fe-8 at. % V, these additional conductive oxides of Fe—V alloys exhibit surprisingly low contact resistance as compared to either copper or iron and show about a 5 to about 20 times reduction in the contact resistance with respect to iron after 400 hours of heating. Similarly, the conductive oxides show about a 1000 to about 5000 times reduction in contact resistance with respect to copper after 400 hours of heating.

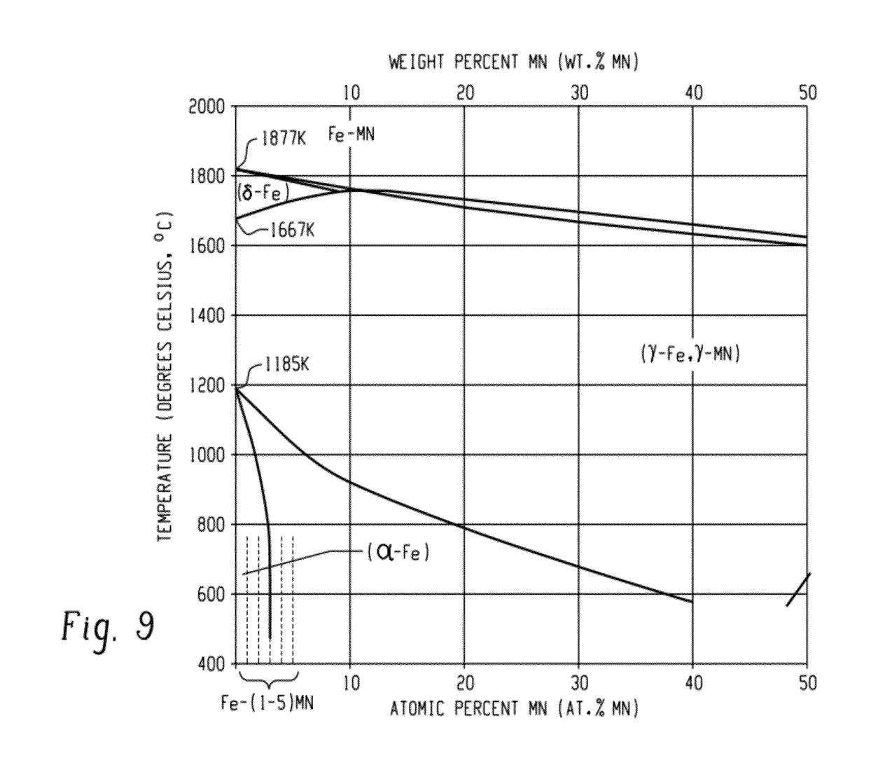

FIG. 9 is a phase diagram of temperature (degrees Celsius, ° C.) versus weight percent Mn (wt. % Mn) and atomic percent Mn (at. % Mn) for an Fe—Mn system. The vertical dashed lines in the lower left-hand portion of the graph in FIG. 9 indicate alloys of iron with 1 at. % Mn, 2 at. % Mn, 3 at. % Mn, 4 at. % Mn, and 5 at. % Mn, which have solid states for each composition below about 1800° C. and a liquid state above this temperature. Based on the phase diagram shown in FIG. 9, from a melt of iron and manganese, an alloy of single phase γ(Fe, Mn), for example, can be formed below about 1650° C. for about 1 at. % Mn to about 10 at. % Mn in a balance of iron.

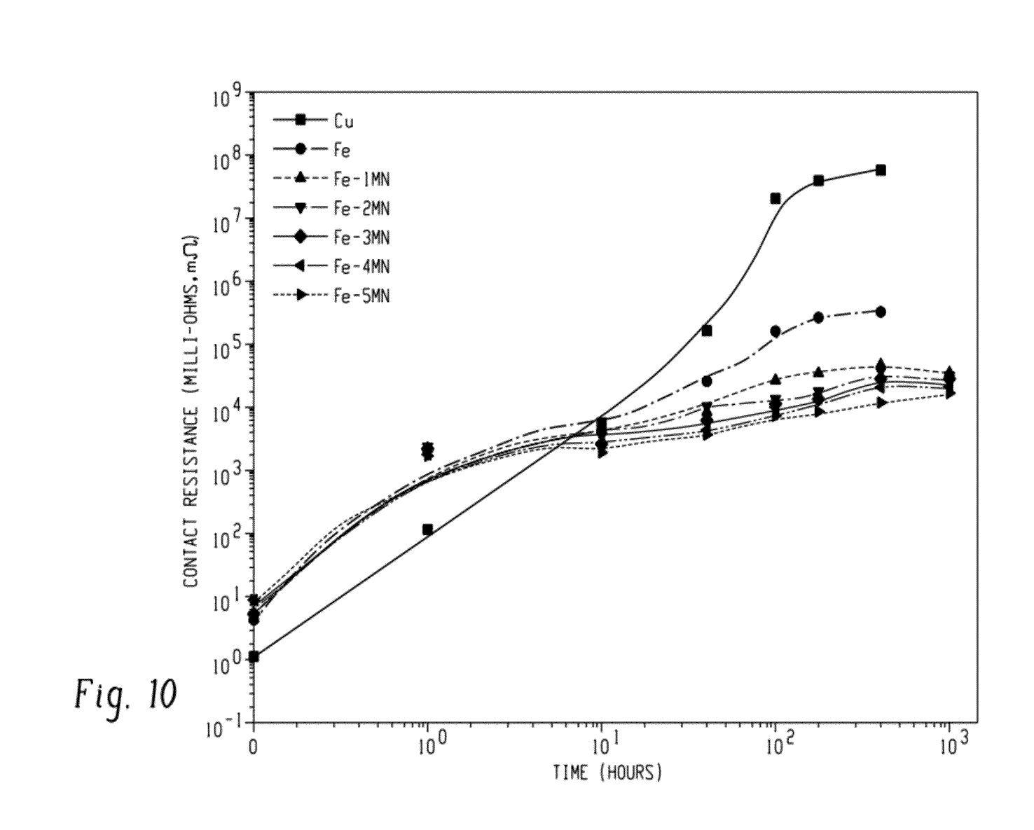

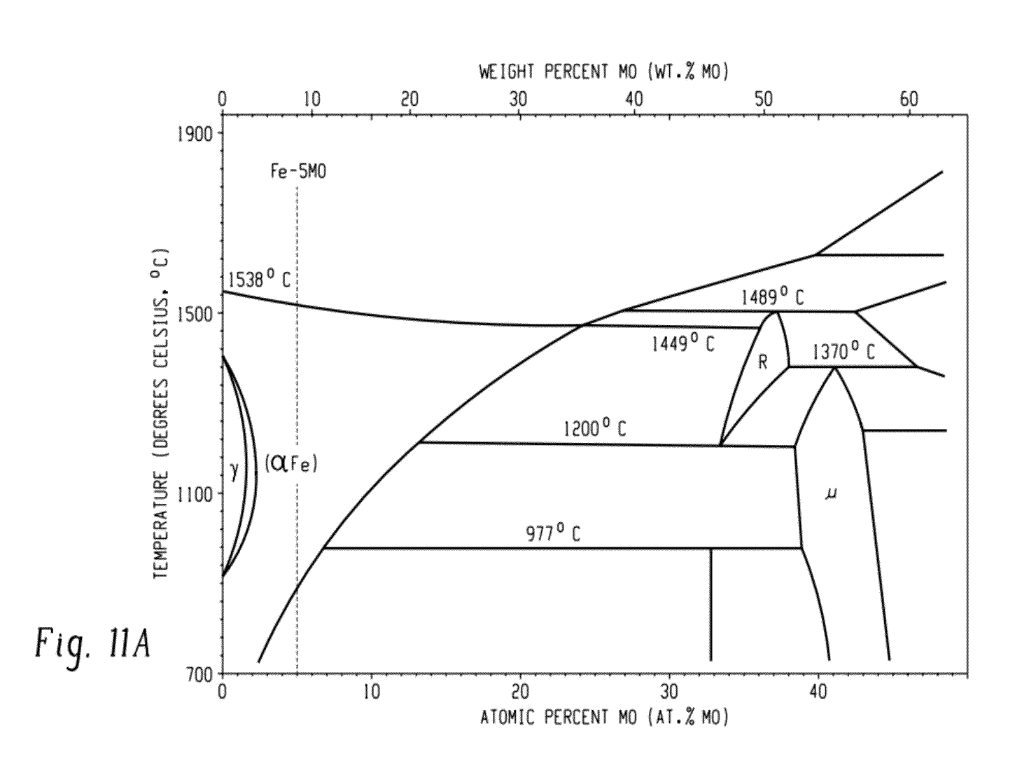

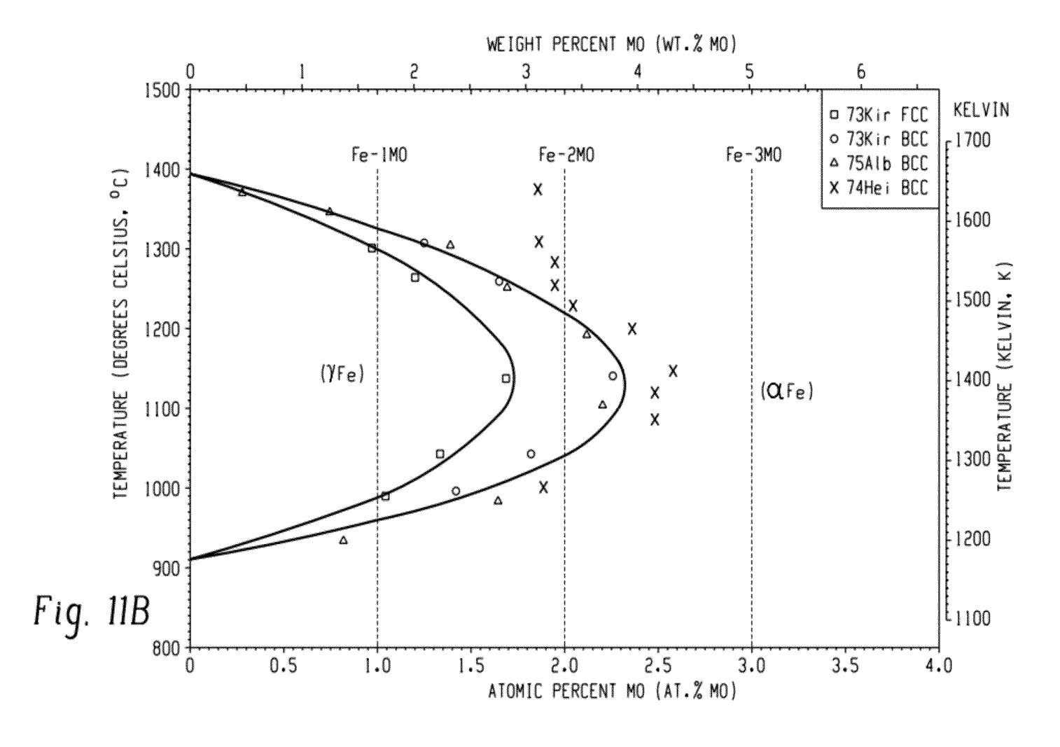

FIG. 10 is a graph of contact resistance (milli-ohms, mΩ) versus oxidation time (hours, hr) for a conductive oxide of an Fe-1 at. % Mn alloy, Fe-2 at. % Mn alloy, Fe-3 at. % Mn alloy, Fe-4 at. % Mn alloy, and Fe-5 at. % Mn alloy and comparative results for copper and iron samples. As shown in FIG. 10, these conductive oxides of the Fe—Mn alloys exhibit surprisingly low contact resistance as compared to either copper or iron. The data for the conductive oxides show about a 5 to about 19 times reduction in the contact resistance with respect to iron after 400 hours of heating. Similarly, they show about a 1300 to about 5000 times reduction in contact resistance with respect to copper after 400 hours of heating.

FIG. 11 are phase diagrams of temperature (degrees Celsius, ° C.) versus weight percent Mo (wt. % Mo) and atomic percent Mo (at. % Mo) in an Fe—Mo system. FIG. 11A has a vertical dashed line that indicates the temperature-dependent phase of an Fe-5 at. % Mo alloy. FIG. 11B, which shows an enlarged portion of the phase diagram shown in FIG. 11A, has vertical lines that depict similar information for an Fe-1 at. % Mo alloy, Fe-2 at. % Mo alloy, Fe-3 at. % Mo alloy, and Fe-4 at. % Mo alloy, which have solid states for each composition below about 1450° C. and a liquid state above about 1540° C. Based on the phase diagram shown in FIG. 11, from a melt of iron and molybdenum, an alloy of single phase α(Fe), for example, can be formed below about 1500° C. for about 1 at. % Mn to about 4 at. % Mn in a balance of iron.

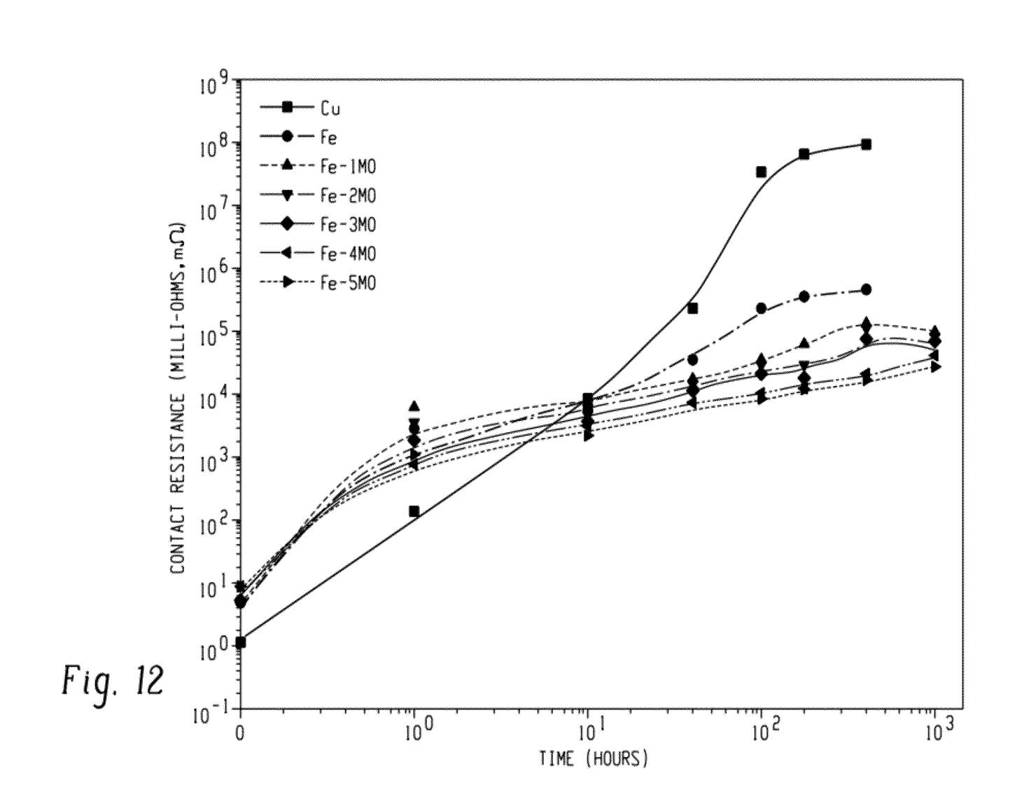

FIG. 12 is a graph of contact resistance (milli-ohms, mΩ) versus oxidation time (hours, hr) for a conductive oxide of an Fe-1 at. % Mo alloy, Fe-2 at. % Mo alloy, Fe-3 at. % Mo alloy, Fe-4 at. % Mo alloy, and Fe-5 at. % Mo alloy and comparative results for copper and iron samples. As shown in FIG. 12 these conductive oxides of the Fe—Mo alloys exhibit surprisingly low contact resistance as compared to either copper or iron and generally have a decreasing contact resistance with an increasing amount of Mo. The data for the conductive oxides show about a 4 to 23 times reduction in the contact resistance with respect to iron after 400 hours of heating. Similarly, they show about a 700 to about 4300 times reduction in contact resistance with respect to copper after 400 hours of heating.

The singular forms “a,” “an,” and “the” include plural referents unless the context clearly dictates otherwise.

Various numerical ranges are disclosed in this patent application. Because these ranges are continuous, they include every value between the minimum and maximum values. The endpoints of all ranges reciting the same characteristic or component are independently combinable and inclusive of the recited endpoint.

Elements and compounds are described herein using standard nomenclature.

All references are incorporated herein by reference.

While the invention has been described with reference to various embodiments, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to any particular embodiment disclosed for carrying out this invention, but that the invention will include all embodiments falling within the scope of the appended claims.

What is claimed is:

1. A composition comprising
a binary alloy of
iron and
one of manganese, molybdenum, or vanadium,
wherein the manganese, molybdenum, or vanadium is present in the binary alloy in an amount effective to form a conductive oxide on the binary alloy,
the oxidation state of the manganese, molybdenum, and vanadium is greater than the oxidation state of the iron in the conductive oxide, and
the conductive oxide has a contact resistance less than 5×10⁴ milli-ohms measured in accordance with ASTM B667-97 (2009).

2. The composition of claim 1, wherein the manganese is present in an amount from 1 at. % to 10 at. % Mn.

3. The composition of claim 2, wherein the manganese is present in an amount from 1 at. % to 5 at. % Mn.

4. The composition of claim 3, wherein the manganese is present in an amount from 3 at. % to 5 at. % Mn.

5. The composition of claim 1, wherein the molybdenum is present in an amount from 1 at. % to 10 at. % Mo.

6. The composition of claim 5, wherein the molybdenum is present in an amount from 1 at. % to 5 at. % Mo.

7. The composition of claim 6, wherein the molybdenum is present in an amount from 1 to 3 at. % Mo.

8. The composition of claim 1, wherein the vanadium is present in an amount from 1 at. % to 30 at. % V.

9. The composition of claim 8, wherein the vanadium is present in an amount from 4 at. % to 20 at. % V.

10. The composition of claim 9, wherein the vanadium is present in an amount from 8 at. % to 12 at. % V.

11. The composition of claim 1, wherein the binary alloy is a single phase.

12. The composition of claim 1, wherein the binary alloy is a solid solution of the manganese, molybdenum, or vanadium in the iron.

13. The composition of claim 1, wherein the binary alloy has a bulk resistivity from 25 nano-ohm-meters to 500 nano-ohm-meters.

14. The composition of claim 1, wherein the binary alloy has a bulk resistivity from 50 nano-ohm-meters to 500 nano-ohm-meters.

15. The composition of claim 1, further comprising the conductive oxide of the binary alloy.

16. The composition of claim 15, wherein the conductive oxide is a single phase, and the manganese, molybdenum, or vanadium is substitutionally incorporated into a lattice of the conductive oxide.

17. The composition of claim 16, wherein a contact resistance of the composition is less than 5×10⁴ milli-ohms.

18. The composition of claim 15, wherein the manganese, molybdenum, or vanadium in the conductive oxide is present in an amount effective to change a relative amount of Fe²⁺ and Fe³⁺ in the conductive oxide.

19. A process of making the binary alloy of claim 1, comprising alloying iron and one of manganese, molybdenum, or vanadium to form the binary alloy.

20. A process of making the composition of claim 1, comprising:
alloying iron and one of manganese, molybdenum, or vanadium to form the binary alloy; and
maintaining the binary alloy under a condition effective to oxidize at least a portion of the binary alloy to form the conductive oxide.

21. An electrical device comprising:
a first component and a second component in a spaced apart relation; and
the composition of claim 1 disposed between and in physical contact with the first component and the second component,
wherein the composition completes an electrical path between the first component and the second component.

22. An electrical device comprising:
a metal substrate; and
a coating comprising the composition of claim 1 disposed on the metal substrate and in electrical contact with the metal substrate.

23. The electrical device of claim 22, further comprising a metallic member to electrically contact the coating.

24. The electrical device of claim 23, wherein the electrical device is a blade connector, push-on connector, crimp connector, multi-pin connector, bolt connector, set screw connector, lug, wedge connector, bolted connector, compression connector, coaxial connector, wall connector, surface mount technology board connector, IPC connector, DIN connector, phone connector, plastic leaded chip carrier socket or surface mount connector, integrated circuit connector, ball grid array connector, staggered pin grid array connector, or bus bar connector.

25. The electrical device of claim 23, wherein the electrical device is a circuit breaker, mercury switch, wafer switch, dual-inline package (DIP) switch, reed switch, wall switch, toggle switch, in-line switch, rocker switch, microswitch, or a rotary switch.

26. An article comprising the electrical device of claim 20.
